(19) United States
(12) Patent Application Publication
(10) Pub. No.: US 2016/0341400 A1
(43) Pub. Date: Nov. 24, 2016

(54) OPTICAL SEMICONDUCTOR LIGHTING APPARATUS

(71) Applicant: Posco LED Company Ltd., Yongin-si (KR)

(72) Inventors: Su Woon LEE, Yongin-si (KR); Sang Hyuk KIM, Yongin-si (KR); Yoon Gil JANG, Yongin-si (KR); Jung Hwa KIM, Yongin-si (KR)

(21) Appl. No.: 14/720,110

(22) Filed: May 22, 2015

(51) Int. Cl. F21V 15/01; F21V 29/74; F21V 29/67

(52) U.S. Cl. CPC F21V 15/01; F21V 29/67; F21V 29/74

(57) ABSTRACT

An optical semiconductor lighting apparatus including an upper part including a cover and a cooling member coupled to a lower surface of the cover and a lower part including a housing forming an inner space, a heat radiation member coupled to a lower side of the housing, and a light emitting member coupled to a lower surface of the heat radiation member. The upper part is mounted on top of the lower part and the cooling member is disposed over the heat radiation member at a predetermined distance.

### BACKGROUND

1. Field

Exemplary embodiments relate to an optical semiconductor lighting apparatus. More particularly, exemplary embodiments relate to an optical semiconductor lighting apparatus that is lightweight, small in size, and easily assembled. In addition, the optical semiconductor lighting apparatus provides adequate space for heat radiation with an air inlet and outlet. Furthermore, exemplary embodiments relate to an optical semiconductor lighting apparatus that is able to prevent dust and other harmful materials from sticking to it.

2. Discussion of the Background

Recently, the demand for lighting apparatuses using an optical semiconductor is increasing rapidly because such apparatuses have a long life span and are operable with a minimal amount of electric power. Furthermore, unlike some conventional lighting apparatuses, optical semiconductor lighting apparatuses are more environmentally friendly because they do not use toxic substances (e.g., mercury). A light emitting diode (LED) is a typical element using the optical semiconductor.

The LED is used as a light source of the lighting apparatuses and many companies are using the lighting apparatuses in their factories since such apparatuses provide high electrical efficiency and cost savings. However, the apparatuses need additional protection from severe conditions sometimes found in factories, such as high temperature. In addition to external heat potentially found in harsh conditions, the lighting apparatus itself includes internal heat sources (e.g., a switching mode power supply (SMPS) and LEDs disposed on a printed circuit board PCB). Therefore, the lighting apparatus needs to dissipate heat it may receive from internal sources (e.g., SMPS and LEDs) and from external sources (e.g., severe factory conditions) through cooling elements.

Because SMPS and LEDs are installed inside of the lighting apparatus, it is necessary to mount cooling elements in the lighting apparatus. Unfortunately, this generally makes the lighting apparatus too large and heavy. Thus, designing and selecting the appropriate number of internal elements of the lighting apparatus as well as the size and shape of the internal elements is extremely important. Properly designed internal elements make the manufacturing and assembly of the lighting apparatus easier and faster. In addition, a lighting apparatus with properly designed internal elements may exhibit a reduction in the size and weight of the apparatus providing cost savings in assembly and installation.

Lighting apparatus used in factories may be vulnerable to harmful materials such as dust that may break down the lighting apparatus. Thus, lighting apparatuses need an effective way to block and clean up harmful materials to prevent lighting apparatuses from breaking down.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide an optical semiconductor lighting apparatus that is easy to assemble, provides adequate space for heat radiation, and prevents harmful material from sticking to it.

Additional aspects will be set forth in the detailed description which follows, and, in part, will be apparent from the disclosure, or may be learned by practice of the inventive concept.

An exemplary embodiment discloses an optical semiconductor lighting apparatus including an upper part comprising a cover and a cooling member coupled to a lower surface of the cover, a lower part comprising a housing forming an inner space, a heat radiation member coupled to a lower side of the housing, and a light emitting member coupled to a lower surface of the heat radiation member. The upper part is mounted on top of the lower part and the cooling member is disposed over the heat radiation member at a predetermined distance.

In an embodiment, the cover has an air inlet configured to allow fresh air to enter the apparatus.

In an embodiment, the air inlet is formed along a side surface of the cover in circumferential direction.

In an embodiment, the cooling member includes a fan disposed in the inner space of the housing and coupled to a lower surface of a first bracket, the first bracket coupled to a lower surface of a second bracket, and the second bracket coupled to the lower surface of the cover.

In an embodiment, the first bracket includes an edge piece forming an outer peripheral structure, a center piece disposed over the fan, and an inner piece connecting the center piece and the edge piece.

In an embodiment, an inner piece includes a guide groove configured to receive an electric power line.

In an embodiment, the cooling member further includes a ring surrounding an upper part of the fan.

In an embodiment, the second bracket forms a power supply space for a power supply.

In an embodiment, the housing includes an upper surface and a top hole in a center portion of the upper surface configured to receive a part of the cooling member to be disposed inside the housing.

In an embodiment, the heat radiation member includes a heat radiation plate comprising an upper surface, a center part, and a lower surface, wherein the lower surface is coupled the light emitting member and the center part is directly facing the cooling member, and a heat radiation fin disposed on the upper surface of the heat radiation plate.

In an embodiment, the heat radiation fin includes a chamfered portion at an end toward the center part of the heat radiation plate.

In an embodiment, the heat radiation plate comprises an air outlet at an outer peripheral edge.

An exemplary embodiment also discloses an optical semiconductor lighting apparatus including a housing forming an inner space comprising an a lower side that is wider than an upper side, a cover disposed on the upper side of the housing, a cooling member coupled to a lower surface of the cover and having a part disposed in the inner space of the housing, a heat radiation member coupled to the lower side of the housing; and a light emitting member coupled to a lower surface of the heat radiation member. The cover and the cooling member are formed as a single unit and mounted on the upper side of the housing.

In an embodiment, the cover includes an air inlet formed along a side surface of the cover in circumferential direction and configured to allow fresh air to enter the apparatus.

In an embodiment, the cooling member includes a fan disposed in the inner space of the housing and coupled to a lower surface of a first bracket, the first bracket coupled to a lower surface of a second bracket, and the second bracket coupled to the lower surface of the cover.

In an embodiment, the first bracket includes an edge piece forming an outer peripheral structure, a center piece disposed over the fan, and an inner piece connecting the center piece and the edge piece.

In an embodiment, the inner piece includes a guide groove configured to receive an electric power line.

In an embodiment, the cooling member further includes a ring surrounding an upper part of the fan.

In an embodiment, the second bracket forms a power supply space for a power supply.

In an embodiment, the heat radiation member includes a heat radiation plate comprising an upper surface, a center part, a lower surface, and an air outlet at an outer peripheral edge, wherein the lower surface is coupled to the light emitting member and the center part is directly facing the cooling member, and a heat radiation fin disposed on the upper surface of the heat radiation plate, wherein the heat radiation fin comprises a chamfered portion at an end toward the center part of the heat radiation plate.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a perspective view of an optical semiconductor lighting apparatus according to an exemplary embodiment.

FIG. 2 is a bottom view of the optical semiconductor lighting apparatus according to the exemplary embodiment.

FIG. 3 is a top view of the optical semiconductor lighting apparatus according to the exemplary embodiment.

FIG. 4 is a cut-away front view illustrating the inside of the optical semiconductor lighting apparatus according to the exemplary embodiment.

FIG. 5 is an exploded view of each element of the optical semiconductor lighting apparatus according the exemplary embodiment.

FIG. 6 is a perspective view of a lower part of the optical semiconductor lighting apparatus according to the exemplary embodiment.

FIG. 7 is an exploded view of each element of the lower part disclosed in FIG. 6 according to the exemplary embodiment.

FIG. 8 is a perspective view of a heat radiation member in the optical semiconductor lighting apparatus according the exemplary embodiment.

FIG. 9 is a top view of the heat radiation member of FIG. 8 according to the exemplary embodiment.

FIG. 10 is a perspective view of an upper part of the optical semiconductor lighting apparatus according to the exemplary embodiment.

FIG. 11 is an exploded view of each element of the upper part disclosed in FIG. 10 according to the exemplary embodiment.

FIG. 12 is a top view of the upper part in FIG. 10 according to the exemplary embodiment.

FIG. 13 is a bottom view of the upper part in FIG. 10 according to the exemplary embodiment.

FIG. 14 is a perspective view of a part of a cooling member of the upper part in FIG. 10 according to the exemplary embodiment.

FIG. 15 is a perspective view of the optical semiconductor lighting apparatus according the exemplary embodiment including a supporting member.

FIG. 16 is a cross sectional view showing air movement characteristics of the optical semiconductor lighting apparatus according to the exemplary embodiment.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. As such, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

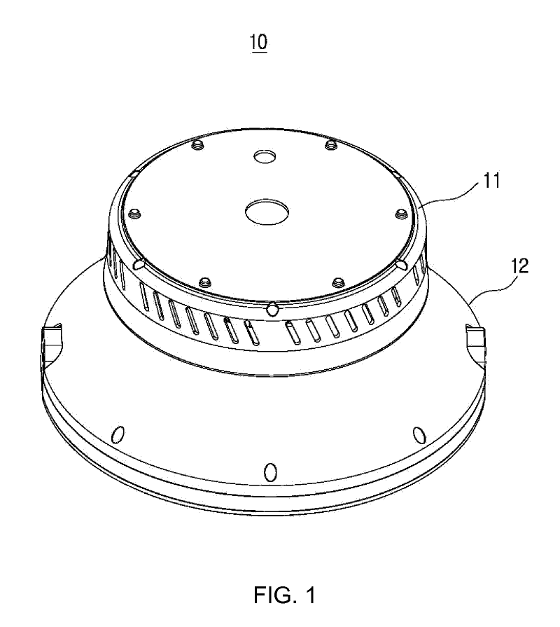

FIG. 1 illustrates an optical semiconductor lighting apparatus 10 according to an exemplary embodiment. The lighting apparatus 10 may include an upper part 11 and a lower part 12.

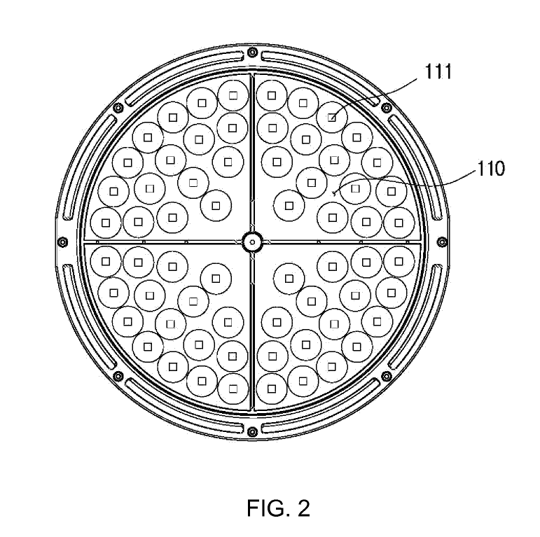

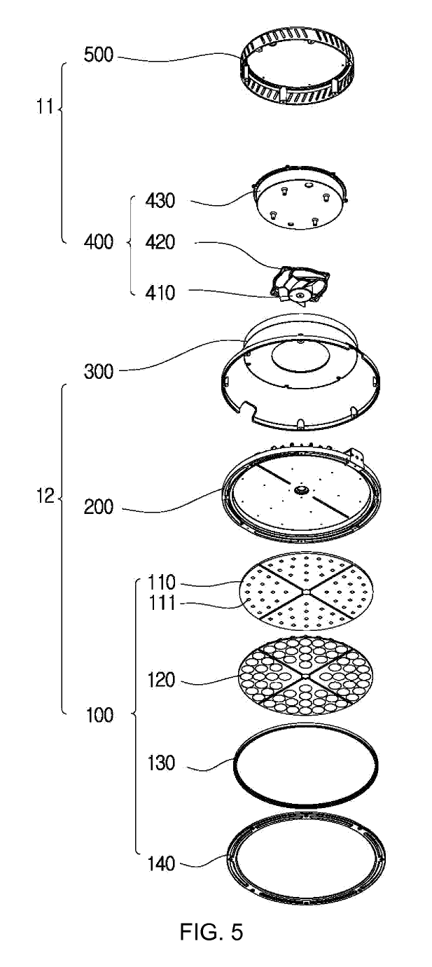

FIG. 2 illustrates the bottom surface of the optical semiconductor lighting apparatus 10 including a plurality of optical semiconductor devices 111. Each of the optical semiconductor devices 111 may be a light emitting diode LED. The optical semiconductor devices 111 are mounted on a printed circuit board PCB 110. The PCB 110 may be a metal core PCB or metal PCB based on a metal board having good thermal conductivity. Each of the optical semiconductor devices 111 generates heat, which is transferred to the PCB 110. The PCB 110 contacts a heat radiation member 200 (FIG. 5). The optical semiconductor devices 111 are a main internal heat source.

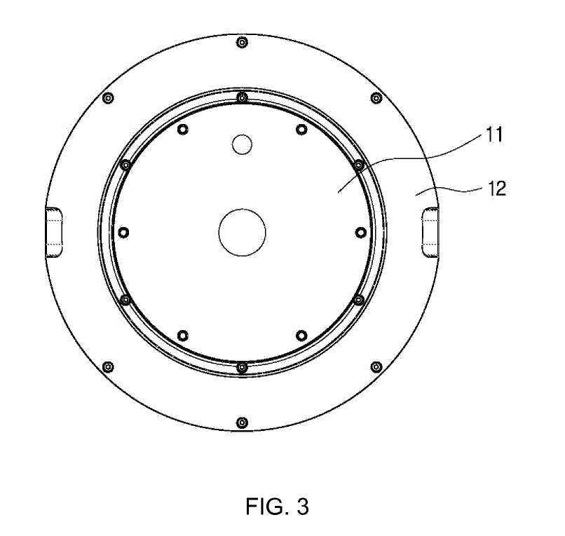

FIG. 3 illustrates a top view of the optical semiconductor lighting apparatus 10 having a circular form. Specifically, the area of the upper part 11 is smaller than area of the lower part 12. Therefore, air heated from the bottom of the optical semiconductor lighting apparatus 10 may be collected at the upper part 11 making it easy to cool all the heated air. A designer may select an appropriate ratio of the area of the upper part 11 to the area of the lower part 12 considering the amount of heated air and its temperature. Because the upper part 11 is smaller than the lower part 12, the optical semiconductor lighting apparatus 10 may include a lower number of cooling elements in the upper part 11 as compared to prior art embodiments, the manufacturing costs of creating the optical semiconductor may be considerably less than prior art embodiments.

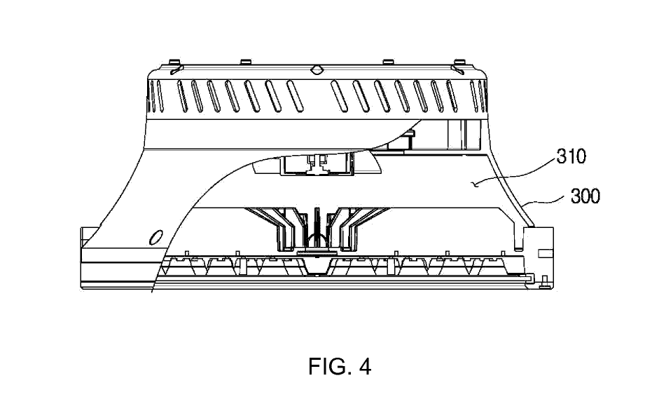

FIG. 4 illustrates that the lower part 12 of the optical semiconductor lighting apparatus 10 may include a housing 300. The upper part 11 may be coupled to the upper side of the housing 300. The upper side of the housing 300 may be smaller than the lower side of the housing 300, and each of the sides may be opened. The housing may form an inner space 310 and the air heated from the bottom may be radiate upwards through the inner space 310 via convection. The inner space 310 may provide enough space to benefit the device by cooling the heated air. According to the form of the housing 300, the inner space 310 may be wider at the lower side and narrower at the upper side.

FIG. 5 illustrates the optical semiconductor lighting apparatus 10 according an exemplary embodiment. The optical semiconductor lighting apparatus 10 may include a light emitting member 100, a heat radiation member 200, a housing 300, a cooling member 400, and a cover 500.

The light emitting member 100 may include optical semiconductor devices 111 mounted on a printed circuit board PCB 110, an optical lens 120, a transparent window 130, and a fixing unit 140.

The PCB 110 may have the optical semiconductor devices 111 on its lower surface and the upper surface. The PCB 110 may be coupled to a lower surface of the heat radiation member 200. The heat generated from the optical semiconductor devices 111 transfers to the heat radiation member 200 through the PCB 110. The PCB 110 may have several unit PCBs. The form of the unit PCB may be fan-shaped but it is not limited thereto. As described above, the PCB 110 may be made of metallic materials having a high thermal conductivity.

The optical lens 120 may cover the PCB 110. The optical lens 120 may have a plurality of unit lenses which correspond to the optical semiconductor devices 111 mounted on the PCB 110. Corresponding to the PCB 110, the optical lens 120 may have several units depending on the number of the unit PCBs. The optical lens 120 adjusts an angle of light emitted from the optical semiconductor devices 111 to prevent or effect the diffusion of the light.

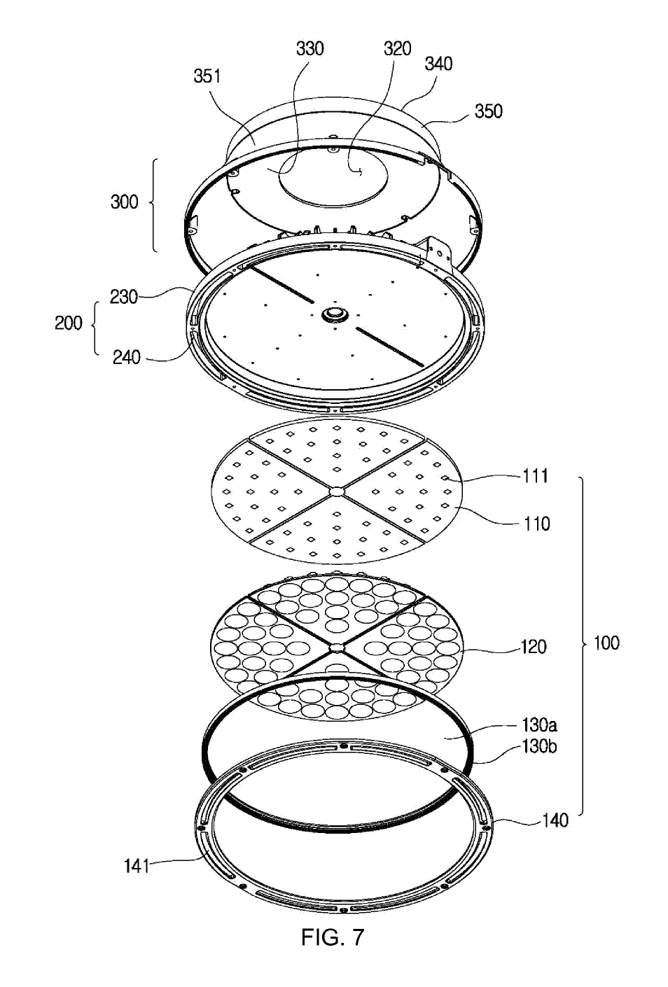

The transparent window 130 may include transparent board 130a and packing 130b which surrounds the edge of the transparent board 130a (FIG. 7). The transparent window 130 may cover the optical lens 120 and also stably fix the lens 120 by pressing it with the fixing unit 140. The fixing unit 140 may be coupled to the lower surface of the heat radiation member 200 and press the edge of the transparent window 130 to the edge of the lower surface of the heat radiation member 200. The fixing unit 140 may be formed as a ring. The transparent window 130 prevents the diffusion of the light emitted from the optical semiconductor devices 111.

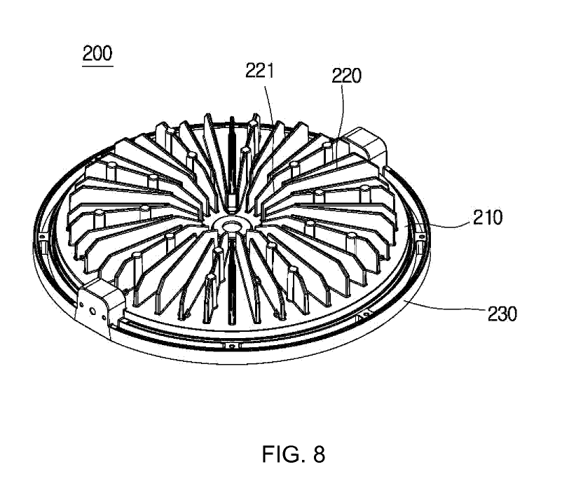

Referring to FIGS. 5 and 8, the heat radiation member 200 may include a heat radiation plate 210 and heat radiation fins 220.

The heat radiation plate 210 has PCB 110 with the optical semiconductor devices 111 as a heat source mounted at the lower surface thereof so that the heat radiation plate 210 effectively absorbs the heat conducted from the PCB 110 and transfers the heat to the heat radiation fins 220. The area of the heat radiation plate 210 may be designed to correspond to the area of the PCB 110 for the heat radiation plate 210 to absorb the heat from the optical semiconductor devices 111 completely by surface-to-surface contact.

The heat radiation fins 220 may be formed on the upper surface of the heat radiation plate 210. Each of the heat radiation fins 220 absorbs the heat conducted from the heat radiation plate 210 and radiates the heat to the inner space 310 of the housing 300 (FIG. 4).

The housing 300 may include a lower side that is bottom-opened and an upper side which is top-opened. The lower side of the housing 300 may be coupled to the heat radiation member 200 and the cooling member may be disposed on the upper side of the housing 300. As described above, the housing 300 forms the inner space 310 and the heated air may collect in the inner space 310 through convection. The inner space 310 may provide enough space for the heated air to cool more easily. The opened upper side of the housing 300 is configured to allow fresh air to enter the inner space for cooling.

Referring to FIG. 5, the cooling member 400 may include a fan 410, a first bracket 420, and a second bracket 430. The fan 410 may be coupled to the first bracket 420 and the first bracket 420 may be mounted on the lower surface of the second bracket 430. The second bracket 430 may provide a power supply space for a switching mode power supply SMPS (not shown) which is an additional internal heat source. The cooling member 400 is coupled to the lower side of the cover 500. The cooling member 400 may be disposed in the inner space 310 of the housing 300 through the top opened upper side of the housing 300 (FIG. 4). The cooling member 400 is over the heat radiation member 200 at a distance vertically and provides fresh air downward to cool the heat radiation member 200.

As mentioned above with reference to FIGS. 4 and 5, the inner space 310 of the housing 300 provides enough space for air convection which is helpful in decreasing the temperature of the heated air. The cooling member may accelerate the air convection in that space. To secure enough space for the convection, the cooling member 400 is preferably disposed over the heat radiation member at a distance since the whole size of the inner space 310 may increase or decrease depending on the vertical distance between the cooling member 400 and the heat radiation member 200. The designer may determine an appropriate distance, considering the amount of heat generated from the optical semiconductor lighting apparatus 10.

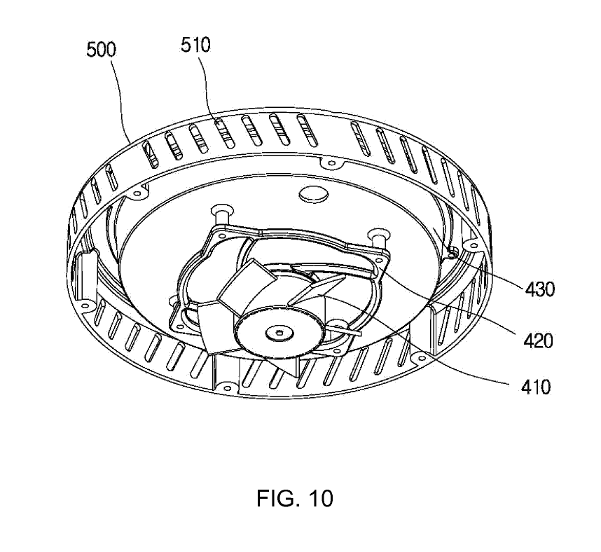

Referring to FIGS. 5 and 10, the cover 500 may be mounted on the upper side of the housing 300 and cover the top opened upper side of the housing 300. The cover 500 may have an air inlet 510 which may allow the fresh air to enter the optical semiconductor lighting apparatus 10 according to the exemplary embodiment. The air inlet 510 may be formed at a side of the cover 500 and it may include one or more inlets.

All the elements disclosed in FIG. 5 may be coupled to each other by using bolts but it is not limited thereto.

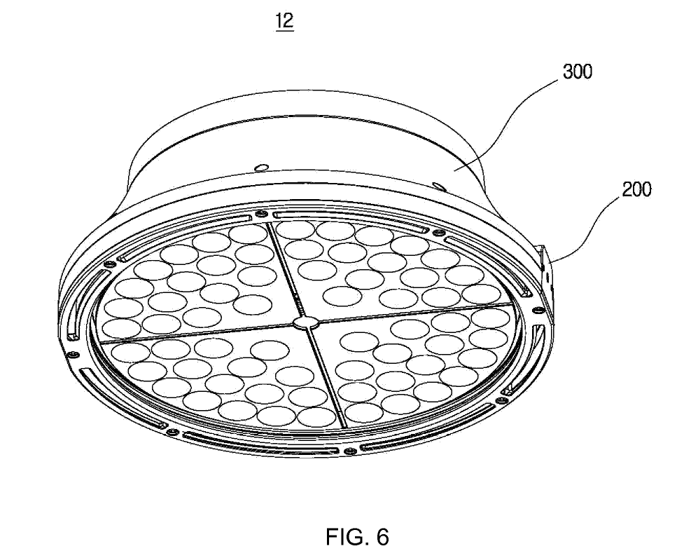

FIGS. 6 and 7 disclose an assembly and elements of the lower part 12, including the light emitting member 100, the heat radiation member 200, and the housing 300 of the optical semiconductor lighting apparatus 10, according to an exemplary embodiment.

Referring to FIGS. 5 and 6, the light emitting member is disposed at the lower side of the housing 300 and covers it. The housing 300 surrounds the heat radiation member 200 and has the light emitting member 100 under the heat radiation member 200. The lower part 12 itself may has been prepared and provided as one unit before starting the assembling process of the optical semiconductor lighting apparatus 10, and this may contribute to easier and faster assembly of the apparatus 10.

Referring to FIGS. 5 and 7, the housing 300 may have a top hole 320 which may be formed in the center portion of an upper surface 330 of the housing 300. A part of the cooling member 400 such as the fan 410 may be disposed inside of the housing 300 through the top hole 320. Therefore, a vertical height of the optical semiconductor lighting apparatus 10 may be reduced so that it is easy to install the apparatus 10. The upper surface 330 of the housing 300 may surround the top hole 320 and support a part of the cooling member 400 and enable the cooling member 400 to be disposed stably on the upper side of the housing 300. An upper edge 340 of the housing 300 may be formed to correspond to the outer peripheral edge of the cover 500 and an upper side surface 350 of the housing may surround and protect a part of the cooling member 400 such as the second bracket 430 (FIG. 5). The lower side surface 351 of the housing 300 may extend downwardly from the bottom of the upper side surface 350. As described above, the housing may form the inner space 310 that accommodates the heat radiation member 200 and the cooling member 400 while forming enough space for air convection (FIG. 4).

Referring to FIGS. 5 and 7, the heat radiation member 200 may have a side wall 230 at the outer peripheral edge thereof. The side wall 230 may be formed as one unit with the heat radiation plate 210 (FIG. 8). An air outlet 240 where the heated air passes through may be formed between the side wall 230 and the heat radiation plate 210 (FIG. 8). The heat radiation member may include one or more air outlets 240. Additionally, a couple of the heat radiation fins 220 may connect the heat radiation plate 210 and the side wall 230 with a gap (FIG. 8). The formed gap may be air inlet 240. The side wall 230 also performs heat radiation as a heat radiation member and may be exposed directly to the atmosphere so that it is possible to radiate heat quickly out from the lighting apparatus.

Referring to FIGS. 5 and 7, the PCB 110 with the optical semiconductor devices 111 thereon is disposed under the lower surface of the heat radiation plate 210. The optical lens 120 and the transparent window 130 may cover the PCB 110. The fixing unit 140 may couple the light emitting member 100 to the heat radiation member 200 by pressing the outer peripheral edge of the transparent window 130 and the optical lens 120 to the heat radiation member 200. Additionally, the fixing unit 140 may have an edge hole 141 which corresponds to the air outlet 240 of the heat radiation member 200. Therefore, the heated air in the inner space 310 may easily flow out from the air outlet 240 and the edge hole 141. The lighting emitting member 100 may include one or more edge holes 141.

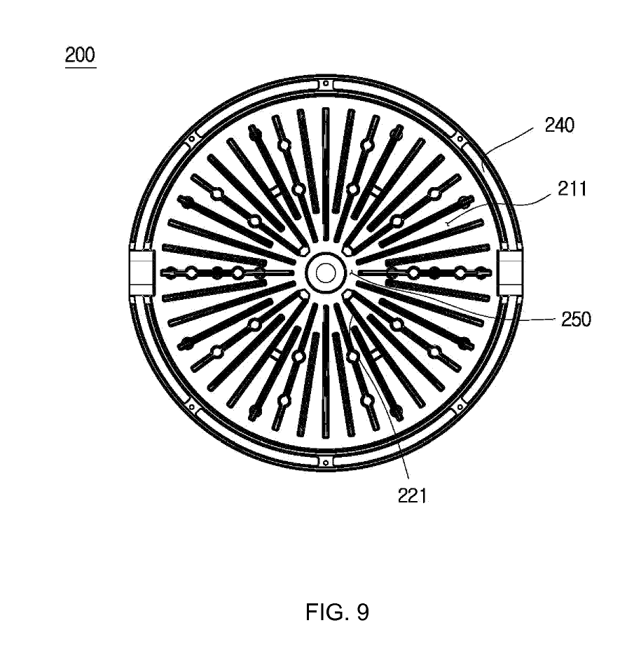

Referring to FIGS. 8 and 9, the heat radiation member 200 may comprise the heat radiation plate 210 and the heat radiation fins 220 protruding therefrom. The heat radiation plate 210 radiates the heat generated from the PCB 110 disposed at its lower surface. The heat radiation plate 210 may be a metallic material having high thermal conductivity. The thermal conductivity may be improved if the heat radiation plate 210 becomes thinner and wider. Considering these attributes, the plate 210 may be optimized depending on the amount of heat generated from the PCB 110 and the installation condition of the apparatus 10. The upper surface of the plate 210 may be a circular shape but it is not limited thereto. Any appropriate shape may be selected from various shapes, such as quadrangle, a polygon, etc., depending on the installation condition and/or to maximize the radiation effect. The heat radiation plate 210 is exposed directly to the inner space 310 so that it can immediately radiate the heat transferred from the PCB 110 (FIG. 5). Simultaneously, the plate 210 is also able to transfer the heat from the PCB 110 to the heat radiation fins 220 protruding therefrom.

A heat radiation fin 220 may have a chamfered portion 221 at an end toward the center part 250 of the heat radiation plate 210. A plurality of the chamfered portions 221 of the heat radiation fins 220 may form a space by surrounding the center part 250. This formed space may be helpful because it enlarges the available space for the convection as described above.

Referring to FIG. 9, each of the heat radiation fins 220 may start from the center part 250 of the heat radiation plate 210 and extend radially. Two of the fins 220 may form a gap 211. The end of the fins 220 may be connected to the side wall 230 and form the air outlet 240 by the gap 211. As described above, the heat radiation plate 210 may have the air outlet at the outer peripheral edge. Thus, the end further from the center part 250 of the fins 220 may not be connected to the side wall 230. The side wall 230 may be a metallic material having a high thermal conductivity with the plate 210 and fins 220.

The center part 250 of the heat radiation plate 210 may have an area that directly faces the fresh air from the cooling member 400 and transfer the air to the gaps 211. Therefore the center part 250 may enhance cooling ability of the heat radiation member 200 by effectively gathering the fresh air and scattering it radially through the gaps 211.

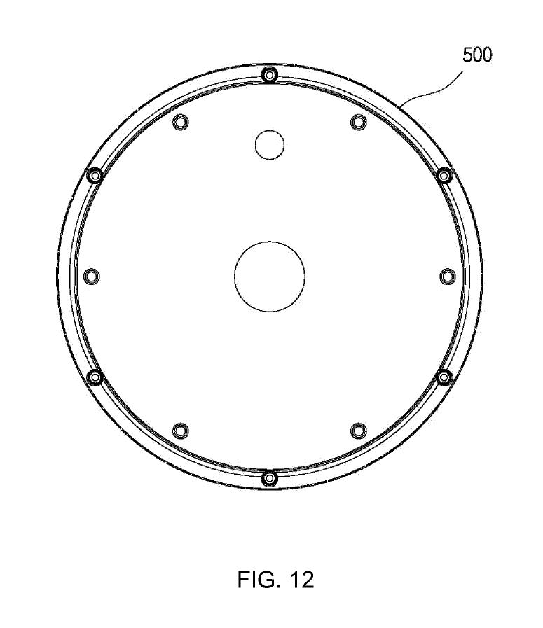

Referring to FIGS. 10, 11, 12, and 13, the upper part 11 of the optical semiconductor lighting apparatus 10 may comprise the cooling member 400 and the cover 500.

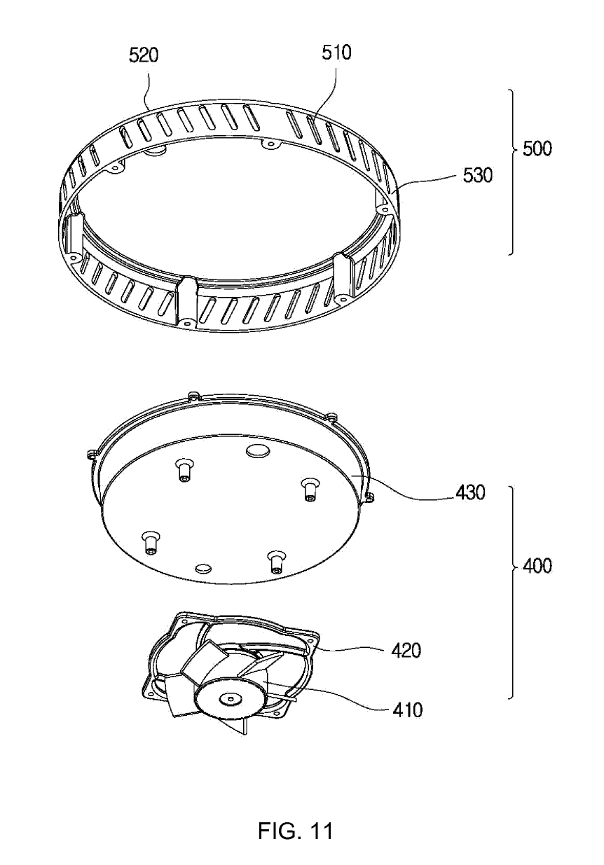

As described above, the cooling member 400 may include a fan 410, a first bracket 420, and a second bracket 430, and each of the elements may be coupled as shown in FIG. 11. The second bracket 430 is coupled to the lower side of the cover 500 and the fan 410 may be disposed in the inner space 310 of the housing 300 through the top hole 320 of the housing 300. The fan 410 is able to be disposed closer to the heat radiation member 200 at a vertical distance and effectively provides fresh air downward to cool the heat radiation member 200, which absorbs the heat generated from the PCB 110.

In an embodiment, a second heat source, the SMPS (not shown) may be disposed inside of the second bracket 430. When the fan 410 operates, the fresh air enters the cover 500 through the air inlet 510 and then hits the side of the second bracket 430 in which SMPS is disposed. Therefore, the fresh air cools the heated second bracket directly.

The cover 500 may have an upper surface 520 and a side surface 530 which extends downwardly from the outer peripheral edge of the upper surface 520 but it is not limited thereto. The air inlet 510 may be formed along the side surface 530 of the cover 500 in a circumferential direction. Further, the air inlet 510 may be also formed in the upper surface 520 of the cover 500. The number and positions of the air inlet 510 may vary depending on the amount of heat generated from the optical semiconductor lighting apparatus 10 according to the exemplary embodiment.

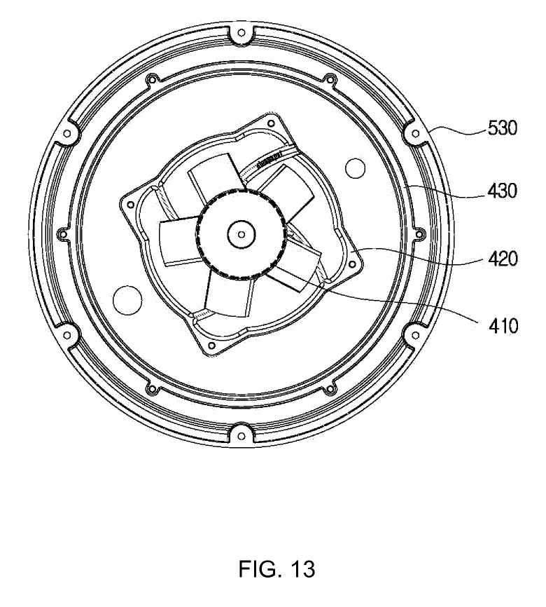

Referring to FIG. 13, the side surface 530 of the cover 500 surrounds the second bracket 430 and this may guide the fresh air into the side of the second bracket 430 directly so that the heat generated from SMPS can be radiated quickly.

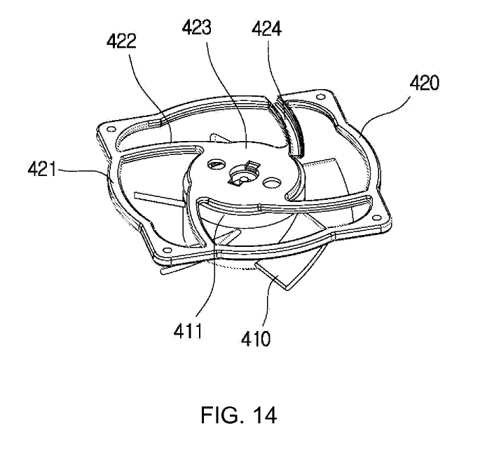

Referring to FIG. 14, a part of the cooling member 400 includes the first bracket 420 and the fan 410.

The fan 410 is coupled to the lower surface of the first bracket 420. A ring 411 may surround an upper part of the fan 410 to protect the fan 410 from being contaminated by harmful materials such as dust. The ring 411 may be an elastic material such as a rubber but it is not limited thereto.

The first bracket 420 may include an edge piece 421, an inner piece 422, and a center piece 423. The edge piece 421 forms an outer peripheral structure and the inner piece 422 connects the center piece 423 to the edge piece 421. This structure may contribute to easy assembly and enhance the efficiency of the fan 410 since the first bracket 420 does not surround the fan 410 so that the fan can send the fresh air radially without any obstacle. The upper side of the fan 410 may be coupled to the lower side of the center piece 423. The first bracket may include a guide groove 424 in any of the inner pieces 422, which is configured to receive an electric power line.

Similarly to the lower part 12, the upper part 11 may be prepared and provided as one unit before starting the assembling process of the optical semiconductor lighting apparatus 10 and this may contribute to easy and faster assembling.

In an embodiment, a manufacturer may fabricate the upper part 11 and the lower part 12 and complete the assembling process by simply connecting the two parts 11 and 12. This structure of the optical semiconductor lighting apparatus 10 may be disassembled easily by separating the two parts when the apparatus 10 needs repairing or cleaning. This may be beneficial in maintaining the apparatus and extending the life span.

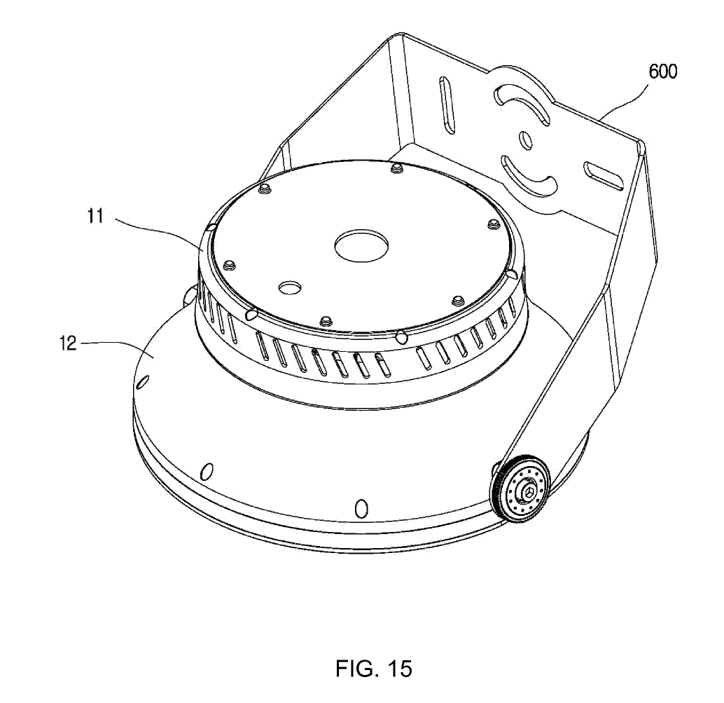

Referring to FIG. 15, the optical semiconductor lighting apparatus 10 according to the exemplary embodiment of the present invention may further comprise a supporting member 600 which may be used for installing the optical semiconductor lighting apparatus 10 on a ceiling. The supporting member 600 may be coupled to the lower part 12 of the apparatus 10 at two points.

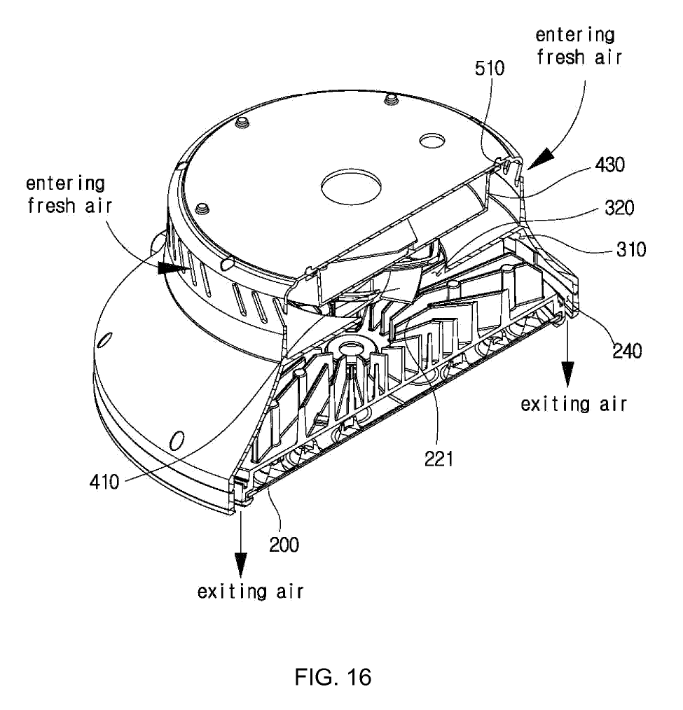

Referring to FIG. 16, the optical semiconductor lighting apparatus 10 according to the exemplary embodiment may have two heat sources such as SMPS (not shown) and the optical semiconductor devices 111 (FIG. 8). As described above, the SMPS may be disposed inside of the second bracket 430 and the optical semiconductor devices 111 mounted on the PCB 110 are disposed under the heat radiation plate 210 of the heat radiation member 200.

The heat generated from the SMPS (not shown) transfers to the second bracket 430 and is radiated from the outer surface of the second bracket 430. The heat generated from the optical semiconductor devices 111 transfers to the heat radiation plate 210 and the heat radiation fins 220. The heat generated from the optical semiconductor devices 11 is then radiated from the surface of the plate 210 and the fins 220.

The air in the inner space 310 of the housing 300 becomes heated by the two heat sources (i.e., SMPS and the optical semiconductor devices 111). The fan 410 of the cooling member 400 moves fresh air into the apparatus 10 through the air inlet 510. The fresh air cools down the surface of the second bracket 430 first and then flows downwardly through the top hole 320 of the housing 300 into the inner space 310. The fresh air that flows into the inner space 310 may travel directly to the center part 250 (FIG. 9) of the heat radiation plate 210, through the gaps 211 (FIG. 9) of the heat radiation fins 220, and then released through the air outlet 240. While the air is traveling through the apparatus 10 it may cool the heat radiation plate 210 and the heat radiation fins 220.

By releasing the fresh air through the air outlet 240, the apparatus 10 is able to prevent harmful materials such as dust from sticking to the outer surface of the light emitting member.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. An optical semiconductor lighting apparatus comprising:
an upper part comprising a cover and a cooling member coupled to a lower surface of the cover; and
a lower part comprising a housing forming an inner space, a heat radiation member coupled to a lower side of the housing, and a light emitting member coupled to a lower surface of the heat radiation member,
wherein the upper part is mounted on top of the lower part, and the cooling member is disposed over the heat radiation member at a predetermined distance.

2. The optical semiconductor lighting apparatus of claim 1, wherein the cover has an air inlet configured to allow fresh air to enter the apparatus.

3. The optical semiconductor lighting apparatus of claim 2, wherein the air inlet is formed along a side surface of the cover in circumferential direction.

4. The optical semiconductor lighting apparatus of claim 1, wherein the cooling member comprises:
a fan disposed in the inner space of the housing and coupled to a lower surface of a first bracket, the first bracket coupled to a lower surface of a second bracket, and the second bracket coupled to the lower surface of the cover.

5. The optical semiconductor lighting apparatus of claim 4, wherein the first bracket comprises:
an edge piece forming an outer peripheral structure;
a center piece disposed over the fan; and
an inner piece connecting the center piece and the edge piece.

6. The optical semiconductor lighting apparatus of claim 5, wherein an inner piece comprises a guide groove configured to receive an electric power line.

7. The optical semiconductor lighting apparatus of claim 4, wherein the cooling member further comprises a ring surrounding an upper part of the fan.

8. The optical semiconductor lighting apparatus of claim 4, wherein the second bracket forms a power supply space for a power supply.

9. The optical semiconductor lighting apparatus of claim 1, wherein the housing comprises an upper surface and a top hole in a center portion of the upper surface configured to receive a part of the cooling member to be disposed inside the housing.

10. The optical semiconductor lighting apparatus of claim 2, wherein the heat radiation member comprises:
a heat radiation plate comprising an upper surface, a center part, and a lower surface, wherein the lower surface is coupled to the light emitting member and the center part is directly facing the cooling member; and
a heat radiation fin disposed on the upper surface of the heat radiation plate.

11. The optical semiconductor lighting apparatus of claim 10, wherein the heat radiation fin comprises a chamfered portion at an end toward the center part of the heat radiation plate.

12. The optical semiconductor lighting apparatus of claim 10, wherein the heat radiation plate comprises an air outlet at an outer peripheral edge.

13. An optical semiconductor lighting apparatus comprising:
a housing forming an inner space comprising a lower side that is wider than an upper side;
a cover disposed on the upper side of the housing;
a cooling member coupled to a lower surface of the cover and having a part disposed in the inner space of the housing;
a heat radiation member coupled to the lower side of the housing; and
a light emitting member coupled to a lower surface of the heat radiation member,
wherein the cover and the cooling member are assembled as a single unit and mounted on the upper side of the housing.

14. The optical semiconductor lighting apparatus of claim 13, wherein the cover comprises an air inlet formed along a side surface of the cover in circumferential direction and configured to allow fresh air to enter the apparatus.

15. The optical semiconductor lighting apparatus of claim 13, wherein the cooling member comprises:
a fan disposed in the inner space of the housing and coupled to a lower surface of a first bracket, the first bracket coupled to a lower surface of a second bracket, and the second bracket coupled to the lower surface of the cover.

16. The optical semiconductor lighting apparatus of claim 15, wherein the first bracket comprises:
an edge piece forming an outer peripheral structure;
a center piece disposed over the fan; and
an inner piece connecting the center piece and the edge piece.

17. The optical semiconductor lighting apparatus of claim 16, wherein the inner piece comprises a guide groove configured to receive an electric power line.

18. The optical semiconductor lighting apparatus of claim 15, wherein the cooling member further comprises a ring surrounding an upper part of the fan.

19. The optical semiconductor lighting apparatus of claim 15, wherein the second bracket forms a power supply space for a power supply.

20. The optical semiconductor lighting apparatus of claim 14, wherein the heat radiation member comprises:
a heat radiation plate comprising an upper surface, a center part, a lower surface, and an air outlet at an outer peripheral edge, wherein the lower surface is coupled to the light emitting member and the center part is directly facing the cooling member; and
a heat radiation fin disposed on the upper surface of the heat radiation plate,
wherein the heat radiation fin comprises a chamfered portion at an end toward the center part of the heat radiation plate.
